(19) United States
(12) Patent Application Publication
(10) Pub. No.: US 2008/0162915 A1
(43) Pub. Date: Jul. 3, 2008

(54) SELF-HEALING COMPUTING SYSTEM

(76) Inventors: Mark H. Price, Placitas, NM (US); Jim S. Baca, Corrales, NM (US); Nicholas Woo, Albuquerque, NM (US); Yiming Yang, Albuquerque, NM (US); Ajith K. Illendula, Albuquerque, NM (US)

Correspondence Address: INTEL CORPORATION;c/o INTELLEVATE, LLC, P.O. BOX 52050, MINNEAPOLIS, MN, 55402, US

(21) Appl. No.: 11/618,554

(22) Filed: Dec. 29, 2006

(51) Int. Cl. G06F 15/177

(52) U.S. Cl. 713/2

(57) ABSTRACT

Methods and apparatus for software recovery in a computing system are disclosed. Software installation is authorized, for example, by a user providing a password or a finger print or some other authorization mechanism. The software may then be installed to a flash memory drive. Write access to the flash memory drive is disabled upon completion of the software installation to the flash memory drive. The software is also installed to a system hard drive. If any files of the software installation become corrupted on the hard drive, the corrupted files may be restored from corresponding uncorrupted files of the software installation on the flash memory drive. Restoring the corrupted files may be accomplished by rebooting into a pre-boot BIOS mode and then authorizing the BIOS to remove the corrupted files and to replace them with a copy of the uncorrupted files from the flash memory drive.

### FIELD OF THE DISCLOSURE

This disclosure relates generally to the field of computer systems. In particular, the disclosure relates to techniques for recovery in the event of an operating system or other critical files becoming corrupted on the system hard drive.

### BACKGROUND OF THE DISCLOSURE

In modern computer systems, virus protection and installation recovery are issues of concern for personal computer systems, corporate desktop systems and laptop systems, technical workstations and server systems around the world.

Backup mechanisms have been designed to provide recovery in the event of corruption by viruses or hard drive failures. Such backup mechanisms may involve a partitioning of the system hard drive to store a backup operating system, and/or for external or network drives to store critical data.

Redundant arrays of independent disk (RAID) systems provide mirrored or duplicated images of disks to provide improved availability and reliability of hard disk systems.

One drawback of such backup mechanisms is that a malicious program such as a virus may be able to corrupt both the active partition or mirrored drive as well as the backup copies simultaneously and/or before being detected. Another drawback of prior backup mechanisms is that restoration may be difficult and lack integration into the overall system design.

Failover systems are used for servers or networks that require continuous availability or a high degree of reliability. Failover systems typically happen without user intervention (or sometimes automated with manual approval) to switch over to a redundant or standby server system or network service upon failure or abnormal termination. Switchover systems happen with user intervention to switch over to a redundant or standby server, system or network service upon failure or abnormal termination typically in cases where the overall system complexity does not permit failover or in order to perform system maintenance, such as updating the system software. A failback system, on the other hand, restores a server, system or network service in failure back to its original state.

Such prior systems are typically expensive to implement and require a great deal of technical proficiency to manage. As with backup mechanisms restoration may be difficult and lack integration into the overall system design.

What is desired is a mechanism to securely install and update operating systems or other software and to efficiently recover from corruption of the operating system installation or other software installations or upon failure or abnormal termination, which is integrated into the system and does not require a great deal of technical proficiency to manage. To date, the advantages of integrating such protection and installation recovery features into the overall system design have not been fully utilized.

### BRIEF DESCRIPTION OF THE DRAWINGS

The present invention is illustrated by way of example and not limitation in the figures of the accompanying drawings.

FIG. 1 illustrates one embodiment of a self-healing computing system.

FIG. 2 illustrates a flow diagram for one embodiment of a process for installation and restoration of software in a self-healing computing system.

FIG. 3 illustrates a flow diagram for another embodiment of a process for installation, update and restoration of software in a self-healing computing system.

FIG. 4 illustrates another embodiment of a self-healing computing system.

### DETAILED DESCRIPTION

Disclosed herein are processes and apparatus for operating system or other software recovery in a computing system. An initial software installation is authorized, for example, by a user providing a password or a finger print or some other authorization mechanism. The software may then be installed to a flash memory drive. Write access to the flash memory drive is disabled upon completion of the software installation to the flash memory drive. The software is also installed to the system hard drive. If any files of the software installation become corrupted on the hard drive, the corrupted files may be restored from corresponding uncorrupted files of the software installation on the flash memory drive. Restoring the corrupted files may be accomplished in one embodiment by rebooting into a pre-boot BIOS mode and then authorizing the BIOS to remove the corrupted files if necessary and to replace them with a copy of the uncorrupted files from the flash memory drive. Alternatively, if the corrupted files do not affect the operating system, then removal of the corrupted files and replacement with copies of the uncorrupted files from the flash memory drive may be authorized while the operating system is still active and running.

By employing embodiments of the disclosed processes and apparatus, a flash memory in a computing system may be employed to securely install and update operating system or other software and to efficiently recover from any corruption of the operating system installation or other software installations on the system hard drive.

These and other embodiments of the present invention may be realized in accordance with the following teachings and it should be evident that various modifications and changes may be made in the following teachings without departing from the broader spirit and scope of the invention. The specification and drawings are, accordingly, to be regarded in an illustrative rather than restrictive sense and the invention measured only in terms of the claims and their equivalents.

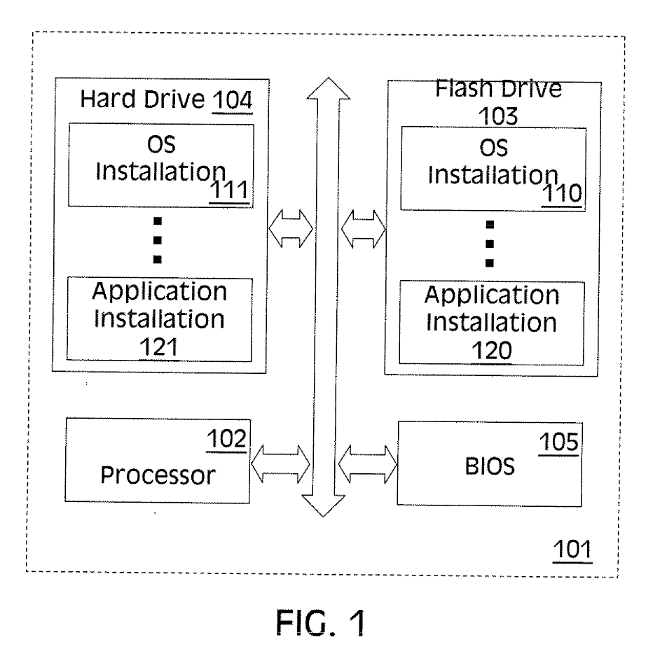

FIG. 1 illustrates one embodiment of a self-healing computing system 101. System 101 may include a processor 102 which may access one or more magnetic storage devices, such as hard drive 104. Hard drive 104 may be used to store, for example, an operating system installation 111 and one or more application software installation 121.

System 101 may further include a flash memory drive 103 to store, for example, an uncorrupted operating system installation 110 corresponding to the operating system installation 111 and/or one or more uncorrupted application software installation 120, respectively corresponding to the operating system installation 111 and or the one or more application software installation 121 on hard drive 104.

When installation of software, for example, the operating system installation 111 or application software installation 121 is authorized responsive to some authorization mechanism, the software may be installed to the flash memory drive 103 and also to the hard disk drive 104. After the software installation to the flash memory drive 103 is complete, write access to the flash memory drive 103 may be disabled, securing it from corruption, for example, by a virus.

If a check of operating system installation 111, or of application software installation 121 stored on hard drive 104 determines that some file of operating system installation 111 or application software installation 121 on hard drive 104 have been corrupted, then the corrupted file may be restored using a corresponding uncorrupted file on flash memory drive 103. For some embodiments, the check may be performed by firmware and/or the BIOS prior to booting of the operating system from hard drive 104.

Some embodiments of system 101 include BIOS 105, where the corrupted file may be restored by rebooting system 101 into a secure pre-boot BIOS mode of BIOS 105, where BIOS 105 may be authorized responsive to some authorization mechanism, to remove the corrupted file form hard drive 104 and to replace it with a copy of the corresponding uncorrupted file from flash memory drive 103. Embodiments of BIOS 105 may also provide for user selectable recovery options.

Thus computing system 101 may employ flash memory drive 103 to recover from a corruption of the operating system installation 111 or other software installations such as application software installation 121 on hard disk drive 404.

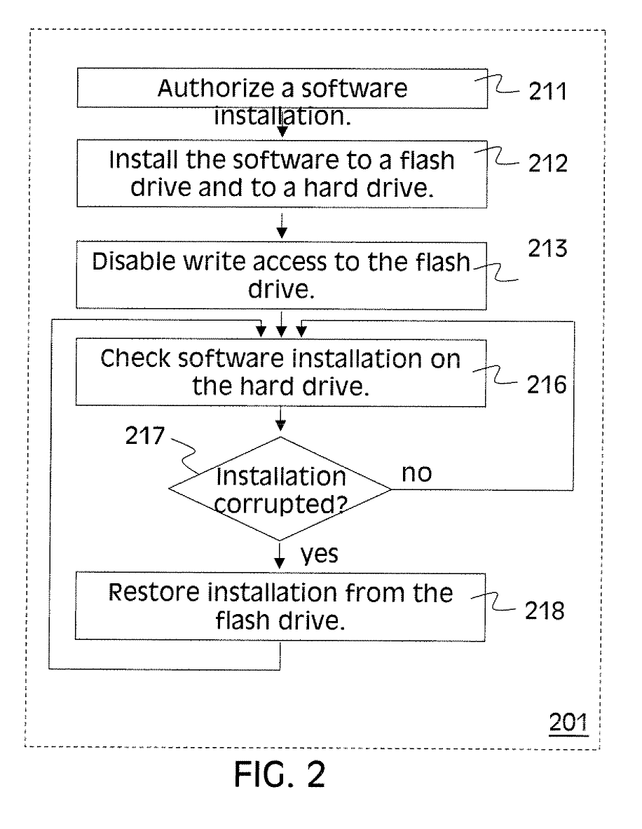

FIG. 2 illustrates a flow diagram for one embodiment of a process 201 for installation and restoration of software in a self-healing computing system. Process 201 and other processes herein disclosed are performed by processing blocks that may comprise dedicated hardware or software or firmware operation codes executable by general purpose machines or by special purpose machines or by a combination of both.

In processing block 211 a software installation is authorized, for example, in response to a user supplied password. In alternative embodiments, software installation may be authorized in response to a user supplied fingerprint or in response to a particular user privilege level, or in response to some other authorization mechanism. In processing block 212 the software is installed to a flash memory drive and also to the system hard drive. For one embodiment, the software may be installed to the flash memory drive and then subsequently copied to the system hard drive. For alternative embodiments, the software may be installed concurrently or sequentially both to the flash memory drive and to the system hard drive. When the software installation to the flash memory drive is complete, write access to the flash memory drive may be disabled in processing block 213. While a logical flow from processing block 212 to processing block 213 is illustrated, it will be appreciated that in some embodiments disabling write access to the flash memory drive in processing block 213 may actually precede some installation of the software to the system hard drive in processing block 212.

Next a check of the software installation on the system hard drive is performed in processing block 216, which may comprise a user initiated check for some embodiments, or routine scanning of the system hard drive, for example, by system and/or virus protection utilities to determine if one or more files of the software installation on the system hard drive have been corrupted. If some file is determined to be corrupted in processing block 217, then the corrupted file or files may be restored in processing block 218 using the corresponding uncorrupted file of the software installation on the flash memory drive. For some embodiments, corruption may be determined by BIOS and/or firmware from the failure to boot an operating system.

For some alternative embodiments, restoring the corrupted file or files may comprise rebooting the system into a secure pre-boot BIOS mode where the BIOS may be authorized, for example, responsive to a user supplied password, a user supplied fingerprint, a user privilege level, or some other authorization mechanism, to remove the corrupted file and to replace it with a copy of the uncorrupted file. Either upon completion of any corrupted file restoration in processing block 218 or in the event that no corrupted files were identified in processing block 217, normal processing may continue, for example, with eventual additional iterations of routine hard drive scanning in processing block 216.

It will be appreciated that process 201 employs a flash memory drive in a computing system to install and to store an uncorrupted copy of the operating system or other software and to efficiently recover from any corruption of these software installations on the system hard drive.

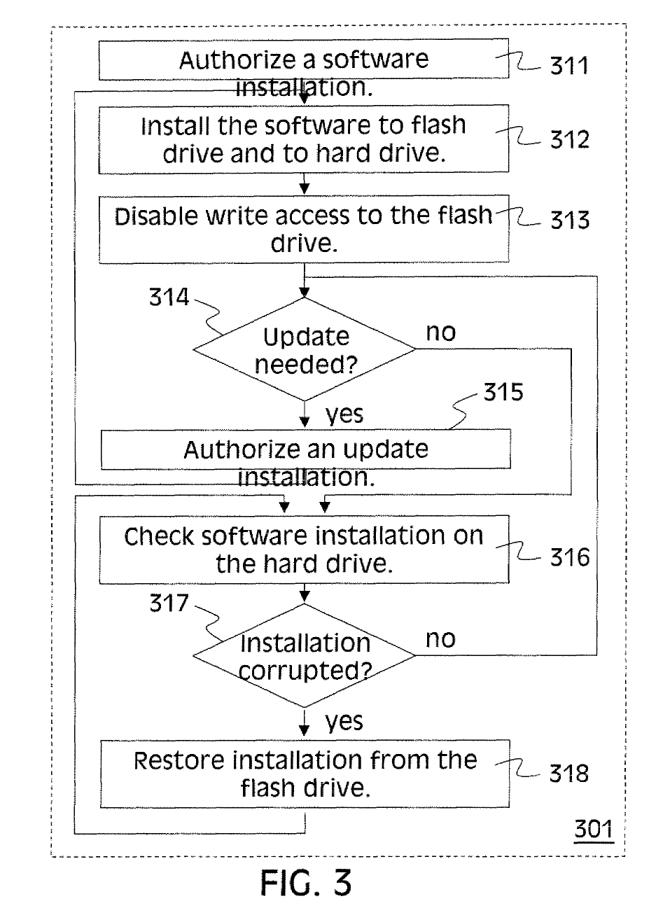

FIG. 3 illustrates a flow diagram for another embodiment of a process 301 for installation, update and restoration of software in a self-healing computing system. A software installation is authorized responsive to some authorization mechanism in processing block 311. In processing block 312 the software is concurrently or sequentially installed to a flash memory drive and also to the system hard drive. Following the software installation to the flash memory drive, write access to the flash memory drive may be disabled in processing block 313. Write access to the flash memory drive may be disabled in processing block 313 prior to, concurrent with or subsequent to installation of the software on the system hard drive in processing block 312.

In the event that an update to the software installation is required in processing block 314, a software update installation is authorized responsive to some authorization mechanism in processing block 315 and process of processing blocks 312 and 313 reiterates and the software update is concurrently or sequentially installed to a flash memory drive and to the system hard drive. Otherwise processing proceeds to processing block 316 where a check of the software installation on the system hard drive is performed in accordance with a user initiated check or a routine scanning of the system hard drive to determine if the software installation on the system hard drive has been corrupted. If it is determined that the software installation on the system hard drive has been corrupted in processing block 317, then in processing block 318 the corrupted installation on the system hard drive may be restored using the corresponding uncorrupted installation on the flash memory drive, which may comprise rebooting the system into a pre-boot BIOS mode where the BIOS may be authorized to remove corrupted files and to replace them with copies of the uncorrupted files. Upon completion of any restoration in processing block 318 or if no corruption was identified in processing block 317, normal processing may continue, with an eventual iteration of routine hard drive scanning in processing block 316.

It will be appreciated that process 301 may employ a flash memory drive in a computing system to install and update an operating system or other software and to efficiently recover from a corruption of the operating system installation or other software installations on the system hard drive.

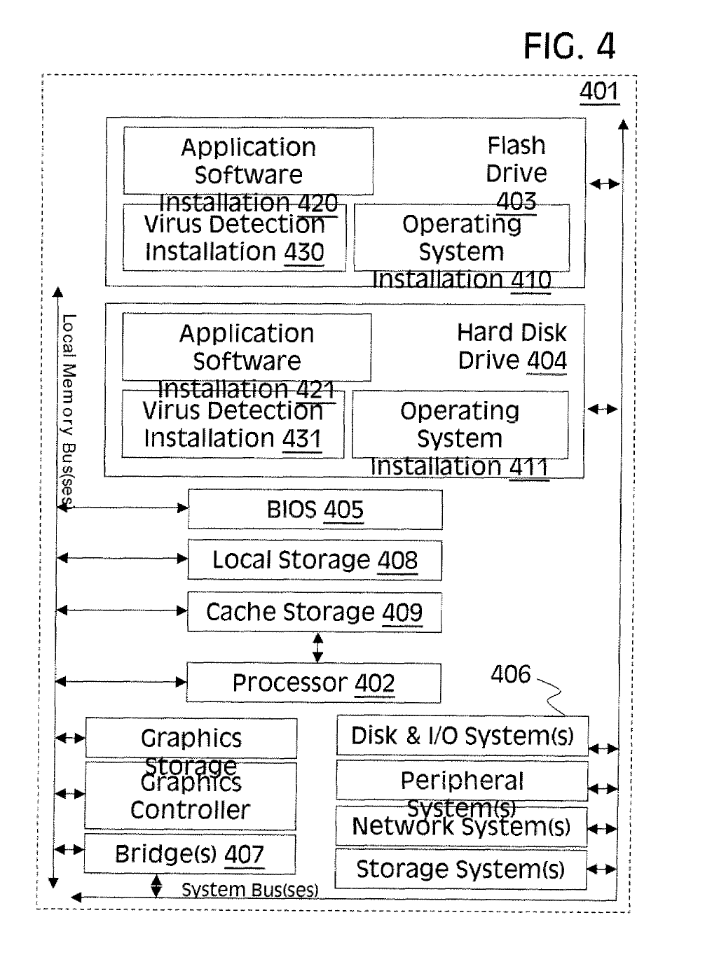

FIG. 4 illustrates another embodiment of a self-healing computing system 401. System 401 may include an addressable memory, local storage 408, and cache storage 409 to store and operating system, data and executable programs; graphics storage and a graphics controller; and various systems optionally including peripheral systems, network systems including network interfaces to stream data for storage in addressable memory, and external storage systems including magnetic storage devices, such as hard disk drive 404 to store, for example, data, an operating system installation 411, an application software installation 421 and an optional virus detection installation 431.

System 401 may include a processor 402, local memory bus(ses), system bus(ses), bridge(s) 407, disk and I/O system(s) 406, wherein the processor 402 may access magnetic storage devices, such as hard disk drive 404 via the controller(s) for disk and I/O system(s) 406 and the system bus(ses) through the controller(s) for bridge(s) 407 to the local memory bus(ses) and local storage 408.

System 401 may further include a flash memory drive 403 to store, for example, an uncorrupted operating system installation 410 corresponding to the operating system installation 411 stored in hard disk drive 404. Flash memory drive 403 may also store, for example, an uncorrupted application software installation 420 and an optional uncorrupted virus detection installation 430, respectively corresponding to the application software installation 421 and the virus detection installation 431 stored in hard disk drive 404.

When installation of software, for example, the operating system installation 411, application software installation 421 or virus detection installation 431 is authorized responsive to a user supplied password, a user supplied fingerprint, a particular user privilege level, or some other authorization mechanism, the software may be installed to the flash memory drive 403 and also to the hard disk drive 404. When the software installation to the flash memory drive 403 is complete, write access to the flash memory drive 403 may be disabled.

Whenever a check of operating system installation 411, application software installation 421 or virus detection installation 431 on the hard disk drive 404, which may comprise a user initiated check or routine scanning of the hard disk drive 404 by system and/or virus protection utilities (for example, virus detection installation 431) determines that one or more files of operating system installation 411, application software installation 421 or virus detection installation 431 on hard disk drive 404 have been corrupted, then the corrupted file or files may be restored using the corresponding uncorrupted file of operating system installation 410, application software installation 420 or virus detection installation 430 on flash memory drive 403.

For some embodiments of system 401, the corrupted file or files may be restored by rebooting system 401 into a secure pre-boot BIOS mode of BIOS 405, where BIOS 405 may be authorized responsive to some authorization mechanism, to remove the corrupted files from hard disk drive 404 and to replace them with copies of the corresponding uncorrupted files from flash memory drive 403. For some alternative embodiments, BIOS 405 provides for a fail-to-boot recovery option to reboot from flash memory drive 403, similar to current safe-mode boot options. Upon completion of the restoration normal processing may again continue.

Thus a process and apparatus have been described employing flash memory drive 403 for efficient recovery in computing system 401 of the operating system installation 411 or other software installations such as application software installation 421 or virus detection installation 431 on hard disk drive 404.

The above description is intended to illustrate preferred embodiments of the present invention. From the discussion above it should also be apparent that especially in such an area of technology, where growth is fast and further advancements are not easily foreseen, the invention be modified in arrangement and detail by those skilled in the art without departing from the principles of the present invention within the scope of the accompanying claims and their equivalents.

What is claimed is:

1. A method for software recovery in a computing system, the method comprising:
authorizing a software installation;
installing the software to a flash memory drive and also to a hard drive;
disabling write access to the flash memory drive upon completion of the software installation to the flash memory drive;
determining if a file of the software installation on the hard drive has been corrupted;
if the file is determined to be corrupted, then restoring the corrupted file using a corresponding uncorrupted file of the software installation on the flash memory drive.

2. The method of claim 1 wherein said authorizing is accomplished responsive to a user supplied password.

3. The method of claim 1 wherein said authorizing is accomplished responsive to a user supplied fingerprint.

4. The method of claim 1 wherein said authorizing is accomplished responsive to a particular user privilege level.

5. The method of claim 1 wherein installing the software to the hard drive comprises copying the software installation from the flash memory drive.

6. The method of claim 1 wherein said determining comprises routine scanning of the hard drive.

7. The method of claim 1 wherein said restoring comprises:
rebooting into a pre-boot BIOS mode; and
authorizing the BIOS to remove the corrupted file and to replace it with a copy of the uncorrupted file.

8. The method of claim 1 wherein said disabling comprises setting the flash memory drive to read-only.

9. An article of manufacture to perform the method of claim 1, the article comprising
a machine-accessible tangible medium including data that, when accessed by a machine, cause the machine to perform the method of claim 1.

10. The article of manufacture of claim 9 wherein said tangible medium comprises a system BIOS.

11. The article of manufacture of claim 10 wherein said tangible medium comprises a hard drive virus detection utility software installation.

12. A method for software recovery in a computing system, the method comprising:
authorizing a software installation;
installing the software to a flash memory drive and also to a hard drive;
disabling write access to the flash memory drive upon completion of the software installation to the flash memory drive;
authorizing a software update installation;
installing the software update to the software installation of the flash memory drive and also of the hard drive;
disabling write access to the flash memory drive upon completion of the software update to the software installation of the flash memory drive;
determining if a file of the software installation on the hard drive has been corrupted;
if the file is determined to be corrupted, then restoring the corrupted file using a corresponding uncorrupted file of the software installation on the flash memory drive.

13. The method of claim 12 wherein said authorizing is accomplished responsive to a user supplied password.

14. The method of claim 12 wherein said authorizing is accomplished responsive to a user supplied fingerprint.

15. The method of claim 12 wherein said authorizing is accomplished responsive to a particular user privilege level.

16. The method of claim 12 wherein installing the software to the hard drive comprises copying the software installation from the flash memory drive.

17. The method of claim 12 wherein said determining comprises routine scanning of the hard drive.

18. The method of claim 12 wherein said restoring comprises:
rebooting into a pre-boot BIOS mode; and
authorizing the BIOS to remove the corrupted file and to replace it with a copy of the uncorrupted file.

19. The method of claim 12 wherein said disabling comprises setting the flash memory drive to read-only.

20. A self-healing computing system comprising:
a magnetic storage device to store a software installation;
a flash memory storage device to store an uncorrupted software installation corresponding to the software installation of the magnetic storage device;
one or more processor-accessible tangible medium including processor executable instructions;
a processor coupled with the magnetic storage device to access the software installation and with the flash memory storage device to access the uncorrupted software installation, said processor further coupled with the one or more processor-accessible tangible medium and in response to accessing said processor executable instructions to:
authorize a first software installation;
install the first software to the flash memory storage device and also to the magnetic storage device;
disable write access to the flash memory storage device upon completion of the first software installation to the flash memory storage device;
determine if a file of the first software installation on the magnetic storage device has been corrupted; and
if the file is determined to be corrupted, then restore the corrupted file using a corresponding uncorrupted file of the uncorrupted first software installation on the flash memory storage device.

21. The system of claim 20 wherein authorizing the first software installation is accomplished responsive to a user supplied password.

22. The system of claim 20 wherein authorizing the first software installation is accomplished responsive to a user supplied fingerprint.

23. The system of claim 20 wherein authorizing the first software installation is accomplished responsive to a particular user privilege level.

24. The system of claim 20 wherein installing the first software to the magnetic storage device comprises copying the first software installation from the flash memory storage device.

25. The system of claim 20 wherein determining if a file of the first software installation on the magnetic storage device has been corrupted comprises routine scanning of the magnetic storage device.

26. The system of claim 20 wherein restoring the corrupted file comprises:
rebooting into a pre-boot BIOS mode; and
authorizing the BIOS to remove the corrupted file and to replace it with a copy of the uncorrupted file of the uncorrupted first software installation on the flash memory storage device.

27. The system of claim 20 wherein disabling write access to the flash memory storage device comprises setting the flash memory storage device to read-only.
